(19) United States
(12) Patent Application Publication
(10) Pub. No.: US 2023/0332308 A1
(43) Pub. Date: Oct. 19, 2023

(54) Sulfur-Doped Tin Oxide Catalysts for Electrochemical Conversion of CO2 into Aqueous Formate/Formic Acid Solutions

(71) Applicant: Battelle Memorial Institute, Columbus, OH (US)

(72) Inventors: Thuy Duong Nguyen Phan, Pittsburgh, PA (US); Douglas Kaufman, Pittsburgh, PA (US); James E. Ellis, Columbus, OH (US)

(21) Appl. No.: 18/134,773

(22) Filed: Apr. 14, 2023

Related U.S. Application Data
(60) Provisional application No. 63/331,212, filed on Apr. 14, 2022.

(51) Int. Cl. C25B 3/26; C25B 3/07; C25B 11/077; C25B 11/032; C25B 11/065

(52) U.S. Cl. CPC C25B 11/077; C25B 3/07; C25B 3/26; C25B 11/032; C25B 11/065

(57) ABSTRACT

S-doped SnO₂ nanoparticles are synthesized by a solid-state process where thermal vaporization of sulfur powder under inert atmosphere to partially sulfurize the SnO₂ nanoparticles. In the catalyst, the sulfur concentration is between 0.1 to 2 at%. A catalyst ink can be prepared from the catalyst containing: a liquid carrier; conductive particles; optionally an ionomer, and the catalyst. A gas diffusion electrode comprising the S-SnO₂ catalyst dispersed onto a carbon paper electrode is also described. Formic acid or formate can be made in a highly efficient process by electrochemically reacting carbon dioxide and water in the presence of the catalyst

### RELATED APPLICATIONS

This application claims the priority benefit of U.S. Provisional Pat. Application Ser. No. 63/331,212 filed 14 Apr. 2023, which is incorporated herein as if reproduced in full below.

Government Rights Clause: This invention was made with government support under contract no. 89243318CFE000003 awarded by the U.S. Department of Energy. The government has certain rights in the invention.

### INTRODUCTION

The electrochemical CO₂ reduction reaction (CO₂RR) is a leading candidate for converting captured CO₂ emissions into value-added chemicals. One such chemical is formic acid (HCOOH), which is electrochemically produced in neutral or acidic electrolytes or as an aqueous formate solution (HCOO⁻) in a buffered or alkaline electrolyte. Formate can then be purified into formic acid using electrodialysis or distillation processes.

Formic acid (HCOOH) is a CO₂RR product with wide agricultural, industrial, chemical and pharmaceutical uses. It is used to preserve animal feed (silage) and can be used as an environmentally benign deicing agent for aviation applications. Formic acid/formate has also been identified as an emerging fuel for fuel cells, a liquid hydrogen carrier with high volumetric capacity (53 g of H₂ per liter), and for biomass upgrading applications. Industrial formic acid production from fossil fuel precursors is extremely carbon intensive, but electrochemically converting CO₂ to formate, followed by down-stream electrodialysis purification into formic acid, could provide a carbon neutral or carbon negative route for producing this versatile chemical.

Tin (Sn)-based materials are some of the most effective CO₂RR electrocatalysts for formic acid/formate production. However, the performance of most Sn-based catalysts is still inadequate for practical applications because of low current densities (typically 10 ~ 25 mA cm_{geo}⁻² in aqueous H-cells, Table 1), high overpotentials, and poor long-term stability. Therefore, further catalyst design efforts is required to boost CO₂RR activity, improve efficiency, and validate operation at high current density in realistic device architectures.

Examples of sulfur-tin based materials for electrochemical CO₂ reduction to formic acid or formate have been reported in the literature by other groups:
(1) Zheng et al., Sulfur-modulated tin sites enable highly selective electrochemical reduction of CO₂ to formate, Joule 2017, 1, 1-12; https://www.sciencedirect.com/science/article/pii/S2542435117300880
   This article reported the synthesis of sulfur-modulated tin (Sn(S)) films onto gold needles by atomic layer deposition of tin sulfide (SnSₓ), followed by selective electrochemical reduction.
(2) Zou et al., Boosting formate production from CO₂ at high current densities over a wide electrochemical potential window on a SnS catalyst, Adv. Sci. 2021, 8, 2004521 https://onlinelibrary.wiley.com/doi/full/10.1002/advs.202004521
   This article employed solvothermal process of using SnCl₂ as a tin precursor, thiourea as sulfur precursor, and ethylene glycol, to synthesize tin sulfide (SnS) nanosheet catalyst.
(3) He et al., Highly selective electrocatalytic reduction of CO₂ to formate over tin(IV) sulfide monolayers, J. Catal. 2018, 364, 125-130. This article reports the synthesis of monolayered tin disulfide (SnS₂) nanosheets by hydrothermal treatment of SnCl₄ precursor and L-cysteine as the sulfur source, following by a lithium intercalation/exfoliation method. This multiple-step, wet-chemical synthetic method is complicated, time-consuming, and not easily scaled.

### SUMMARY OF THE INVENTION

This patent application describes the synthesis of S-doped SnO₂ nanoparticles by a solid-state process where thermal vaporization of sulfur powder under inert atmosphere partially sulfurized the SnO₂ nanoparticles.

In one aspect, the invention provides a method of making a catalyst comprising heating tin oxide powder in the presence of sulfur to produce tin oxide doped with sulfur, wherein the sulfur concentration is between 0.1 to 2 at%, 0.25 to 10 at%, 0.5-5 at%, 0.5-4 at%, or 1-3 at%. In another aspect, the invention provides a catalyst comprising tin oxide doped with sulfur, wherein the sulfur concentration is between 0.1 to 2 at%, 0.25 to 10 at%, 0.5-5 at%, 0.5-4 at%, or 1-3 at%, or 1.3 to 1.5 at%.

In any of its aspects, the invention can be further characterized by one or any combination of the following: wherein the catalyst does not contain a precious metal; wherein the catalyst contains less than 3% or less than 1% or less than 0.5% of a transition metal; wherein the catalyst comprises at least 95% or at least 98% or at least 99% of the sum of the elements Sn, O, and S; the method further comprising mixing the tin oxide and sulfur powders prior to heating; wherein the mixture of tin oxide and sulfur is heated to a calcination temperature of between 350 and 750° C.; mixing tin oxide with sulfur at a SnO₂:S molar ratio of between 1:0.2 and 1:15, more preferably between 1:0.5 and 1:3; wherein calcination temperatures are at least 350° C., or at least 400° C., or at least 500° C., or more preferably at least 600° C., or at least 700° C.; wherein the catalyst has a sulfur content of ± 20% of the amount of sulfur as shown in the energy-dispersive X-ray mapping in FIG. 1 - this corresponds to a sulfur content of 1.2 to 1.6 atom%, likewise the invention can be further characterized by possessing ±10% or ±20% or ±30% of any of the properties evidenced by any of the data shown here; wherein calcination temperatures are in the range of 400 to 700° C.; wherein sulfur atoms are dispersed in a surface of the SnO₂. The invention also includes a catalyst made by reducing the catalyst during a CO2 reduction reaction to form metallic tin in the catalyst.

In another aspect, the invention provides a catalyst ink comprising: a liquid carrier; conductive particles; optionally an ionomer, and the catalyst as described herein. Preferably, the conductive particles comprise conductive carbon, such as carbon black, carbon nanotubes, graphene, graphene oxide, reduced graphene oxide, graphite, amorphous carbon powder, or other suitable carbon materials or nanomaterials. The catalyst ink may also comprise an alkaline ionomer binder, Nafion, polytetrafluoroethylene (PTFE) or some other ionomer binder. The liquid carrier may comprise deionized water and/or isopropanol, methanol, ethanol, or other suitable organic solvent.

In another aspect, the invention provides a method of making a catalyst-containing gas diffusion electrode comprising: applying the catalyst ink onto a carbon paper to form a cathode gas diffusion electrode; and heating the gas diffusion electrode or otherwise drying to remove liquid. In some embodiments, the gas diffusion electrode comprises the catalyst described herein dispersed onto a carbon paper electrode. The gas diffusion electrode may comprises an ionomer or other suitable binder. A S-SnO₂ catalyst-containing gas diffusion electrode may be characterizable by Faradaic efficiency of at least 60%, preferably at least 70%, or between 60 and 85%, or between 70% and about 85%, if measured according to the electrochemical method described in the examples.

In a further aspect, the invention provides a process of making formic acid or formate comprising: electrochemically reacting carbon dioxide and water in the presence of a catalyst comprising tin oxide doped with sulfur, wherein the sulfur concentration is between 0.25 to 10 at%, 0.5-5 at%, 0.5-4 at%, or 1-3 at%. Preferably, the catalyst is disposed on a gas diffusion electrode. The anode of the electrochemical cell may comprise iridium oxide, iridium-carbon, iron oxide, nickel oxide, nickel foam, or any other suitable material. In this process, the catalyst may be disposed on a gas diffusion electrode and the process may have a current density of between 50 and 700 mA cm_{geo}⁻²,or between 100 and 1000 mA cm_{geo}⁻², or between 100 and 300 mA cm_{geo}⁻².

The invention also provides a gas diffusion electrode comprising a cathode gas diffusion electrode wherein the cathode gas diffusion electrode comprises the catalyst described herein. The cathode gas diffusion electrode may comprise a binder and/or conductive particles. The invention also provides a modular system for converting CO₂ with a plurality of electrochemical cells.

In another aspect, the invention also provides a method of making formate or formic acid comprising passing CO₂ into the gas diffusion electrode of any of the above claims. The method may be further characterized by ±10% or ±20% or ±30% of any of the properties and/or measurements described herein. For example, the method may have a Faradaic efficiency of at least 60%, preferably at least 70%, or between 60 and 85%, or between 70% and about 85%.

In the present invention, the catalyst is primarily tin oxide doped with a small amount of sulfur, for example 5 at% to 0.5 at% or 4 at% to 0.5 at% or 3 at% to 1 at% or 2 at% to 0.1 at%. Preferably, the inventive catalyst does not contain precious metals (Ag, Au, Pt, Pd) and in some embodiments does not contain a transition metal.

We have developed a simple synthetic procedure to controllably incorporate sulfur dopant atoms into the catalyst structure. Importantly, our process can modify off-the-shelf SnO₂ powder, which eliminates time consuming and costly synthetic steps, and our synthetic strategy is robust and scalable. Our new sulfur-doped SnO₂ material shows a remarkable increase in the conversion of CO₂ into formate compared with unmodified “off-the-shelf” SnO₂. Data shows a 3-5-fold current increase in performance over undoped SnO₂ and good stability in aqueous H-cell. Acidified formic acid streams can be directly produced in 6 cm² membrane electrode assembly (MEA) electrolyzer cell, showing impressive formic acid production at high current density and good stability over several start/stop cycles. Finally, sulfur is often considered a catalyst poison. In our case, sulfur boosts activity, indicating an inherent tolerance to potential sulfur contaminants in industrial CO₂ streams.

The invention also includes conversion of CO₂ into formate/formic acid.

Advantages of the invention include: new catalyst design for improved performance; carbon negative chemical production; utilization of captured CO₂; low power requirements and energy efficiency; on-demand chemical production; ability to use excess electricity for on-demand chemical production; reduced carbon footprint compared to traditional chemical processes. The catalyst is sulfur doped Sn with only a few atomic percent sulfur, rather than tin sulfide. The catalyst is prepared through a simple, scalable synthetic approach that is appropriate for kg-scale or larger batches. The catalyst is very stable and demonstrates extremely high current density compared to other examples.

The invention also includes: conversion of captured CO₂ into value added products; use of stranded/excess/curtailed renewable energy to power a reactor; modular reactors; use in electrochemical tandem cell to further reduce formic acid to other valuable carbon products.

### BRIEF DESCRIPTION OF THE DRAWINGS

FIG. 1. (A) Scanning transmission electron micrograph and elemental mapping of sulfur-doped SnO₂ catalyst. (B) Electrochemical performance of sulfur-doped SnO₂ nanoparticles compared with commercial SnO₂ in conventional aqueous H-cell reactor.

FIG. 2. CO₂RR performance of S-doped SnO₂ in 6-cm² electrolyzer. (a) Full-cell polarization curve showing cell voltage and formic acid FE vs. total current density. (b) Formic acid partial current density (j_{HCOOH}) and FE over 16 hours at an applied total current density of 200 mA cm⁻².

FIG. 3. Exploded view of an electrolyzer device.

### DETAILED DESCRIPTION OF THE INVENTION

### Synthesis of S-doped SnO₂ Nanoparticles

The invention includes the creation and use of a new sulfur-doped SnO₂ material for the electrochemical conversion of CO₂ into formate or formic acid. The added benefit of electrochemical production is the ability to leverage excess electrons for on-demand chemical production. Utilizing excess renewable (or decarbonized) electricity will allow conversion of CO₂ into carbon neutral or carbon negative products. This represents an enormous reduction in the carbon footprint of traditional fossil-based formic acid production via methane reforming.

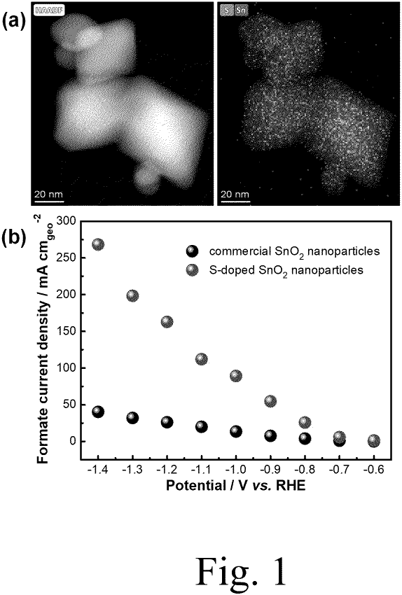

The synthetic procedure involves thermally treating SnO₂ in the presence of sulfur powder under inert atmosphere. The concentration of sulfur dopants incorporated into the SnO₂ can be controlled by varying the calcination temperature and precursor molar ratio, and we found maximum performance was obtained with 1~2 at% concentration of sulfur dopants. Advanced characterization indicates the presence of well-dispersed sulfur dopants in the SnO₂ catalyst (FIG. 1a).

An exemplary procedure, a sample of SnO₂ nanoparticle powder was mixed with an appropriate amount of S powder to achieve a SnO₂: S molar ratio of ~ 1:1 and ground to achieve an even mixture of SnO₂ and S powder. The mixture was then annealed to 600° C. under an inert atmosphere (for example N₂, helium, argon) for an appropriate amount of time. The concentration of S dopants in the SnO₂ samples could be controlled by (i) varying calcination temperature between 400° C. to 700° C. with a fixed SnO₂:S molar ratio of ~1:1; and (ii) adjusting the SnO₂:S molar ratio between 1:0.2 and 1:15 at a fixed annealing temperature.

### Electrochemical CO₂ Reduction in an H-cell

Bulk CO₂ electrolysis measurement was conducted in a gas-tight, two-compartment H-cell separated by a Nafion 117 proton exchange membrane using a SP-300 potentiostat (BioLogic Science Instrument). Each compartment was filled with 60 mL of aqueous 0.1 M KHCO₃ electrolyte (99.99%, Sigma) with 90 mL headspace. A Pt mesh and Ag/AgCl (saturated NaCl, BASi®) were used as the counter and reference electrodes, respectively. The catholyte was continuously purged with CO₂ (99.999%, Butler Gas) at a flow rate of 20 mL min⁻¹ (pH ~ 6.8) under vigorous stirring during the experiments. All applied potentials were referenced against the reversible hydrogen electrode (RHE) (unless otherwise specified), and the uncompensated ohmic resistance was automatically corrected at 85% (iR-correction) using the instrument software in all electrochemical experiments.

The working electrodes were prepared by drop-casting the catalyst ink, which contained 2.8 mg of powder catalysts, 0.32 mg Vulcan VC-X72 carbon black (Cabot), and 40 µL of 5% Nafion® 117 solution binder (Sigma) in 400 µL of methanol, onto 10% polytetrafluoroethylene (PTFE) treated carbon paper (Toray paper 060, Alfa Aesar). The mass loadings were kept at 9.3±0.9 mgᵢₙₖ cm_{geo}⁻² (corresponding to 5.3±0.5 mgsₙo₂ cm_{geo}⁻²).

Chronoamperometric (current vs. time) experiments were performed for 30 min at each applied potential between -0.6 V and -1.4 V vs. RHE and the gas/liquid products were collected every 30 min. The total and partial current densities were normalized to the exposed geometric area of the catalyst (unless otherwise specified). The evolved gas products were collected from the headspace to Tedlar gas-tight bags (Supelco) and then quantified by a PerkinElmer Clarus 600 gas chromatography (GC) equipped with both FID and TCD detectors, using ShinCarbon ST 80/100 Column and He carrier gas. The liquid products collected from the catholytes were filtered with 0.22 µm PTFE filters and analyzed by Shimadzu high-performance liquid chromatography (HPLC) using refractive index and photodiode array detectors, Aminex HPX-87H column (Bio—Rad) and 5 mmol aqueous H₂SO₄ mobile phase.

### Electrochemical CO₂ Reduction Measurement in 6 cm² Full Electrolyzer

The electrolyzer full cell evaluation was performed using a 6 cm² formic acid electrolyzer cell (purchased from Dioxide Materials) at room temperature using a SP-150 potentiostat (BioLogic Science Instrument) with 10 A, 20 V booster (BioLogic). The catalyst ink was composed of 30 mg of S-doped SnO₂ powder, 30 mg of Vulcan XC-72R carbon black, 5 mL of deionized water, 1.97 mL of isopropanol, and 530 µL of Nafion 117 solution (5 wt%). The cathode gas diffusion electrode (GDE) was prepared by brushing the catalyst ink onto 2.5 cm x 2.5 cm 20% PTFE-treated TGP-H-120 Toray carbon paper on a 80° C. hotplate. The S-doped SnO₂ GDE was then heated at 120° C. for 1 hour in inert gas to increase adhesion of the catalyst layer to the GDE. A potentiostat was used to apply a voltage to the electrolyzer full cell and measure current, although other suitable power supplies could be used. CO₂ was fed into the cathode side, and gas products generated at the cathode were measured with GC while liquid formic acid products generated at the cathode were measured with liquid chromatography. Other analytical techniques could also be appropriate for quantifying formic acid products (ion chromatography, nuclear magnetic resonance, colorimetric, etc.).

The cell was assembled with a IrO₂-based anode (Dioxide Materials), a Nafion-based cation exchange membrane (N-324, Chemours), a polycarbonate central flow chamber filled with quartz wool and the S-doped SnO₂ GDE cathode prepared as above. Two peristaltic pumps delivered DIW to the anode side and central chamber at flow rate of 6 mL min⁻¹ and 3.6 mL min⁻¹, respectively. Dry CO₂ was fed to the cathode at a flowrate of 100 mL min⁻¹. The electrolyzer cell was operated step-wise from 50 mA cm_{geo}⁻² to 700 mA cm_{geo}⁻² for 30 min at each current density. The liquid outflow from central chamber was filtered with a 0.22 µm PES syringe filter and then analyzed using a Shimadzu HPLC using refractive index and photodiode array detectors, Aminex HPX-87H column (Bio-Rad) and aqueous H₂SO₄ mobile phase. The gas products from cathode side were analyzed directly from the cell with an in-line PerkinElmer Clarus 590 GC equipped with both FID and TCD detectors.

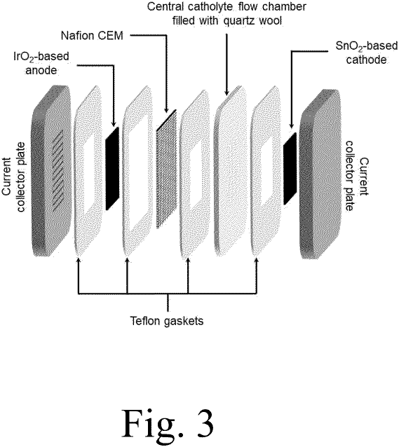

General description of electrolyzer design. FIG. 3 shows an electrolyzer is constructed from a cathode gas diffusion electrode (GDE) coated with the S-SnO₂ catalyst ink. An ion-transport membrane(s), bipolar membrane(s), or other suitable ion transport media separates the cathode from the anode. A negative voltage is applied to the cathode, and a positive voltage is applied to the anode. Electrolyzer devices are commercially available, and the specific design, size, anode, and membrane/ion transport media may vary. The invention also includes an electrolyzer device comprising generalized components of the layers shown in the design of FIG. 3.

### Calculation of Faradaic Efficiency

The Faradaic efficiency (FE) for product i is defined as the percentage of supplied electrons used to convert CO₂ into product i and calculated as follows:

$$F {E}_{i} = \frac{{z}_{i} ∗ F ∗ {n}_{i}}{I ∗ t} = \frac{{z}_{i} ∗ F ∗ {n}_{i}}{Q}$$

where zᵢ is the number of electrons involved in the formation of product i (z = 2 for formic acid/formate, CO, and H₂); F is the Faraday’s constant (96485 C mole⁻¹); nᵢ is the number of moles of product i formed; I is the total current; t is electrolysis time; and Q is total charge in Coulombs passed across the electrode.

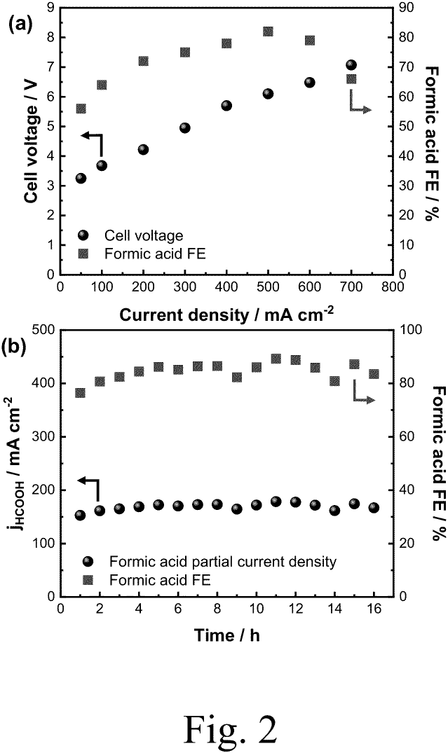

Electrochemical testing in an aqueous H-Cell showed a dramatic enhancement in formate production (current density) and improved Faradaic efficiency compared with as received, commercially available SnO₂ (FIG. 1). Multi-day stability studies in electrolyzer device have also shown S-doped SnO₂ sustained high partial current density (j_{HCOOH} ~150 mA/cm²) over 16 hours of operation with multiple start/stop cycles (FIG. 2). The S-SnO₂ catalyst was electrochemically reduced from as-prepared oxide to metallic working catalyst under the CO₂ reduction reaction.

What is claimed:

1. A catalyst comprising tin oxide doped with sulfur, wherein the sulfur concentration is between 0.1 to 2 at %.

2. The catalyst of claim 1 wherein the catalyst does not contain a precious metal.

3. The catalyst of claim 1 wherein the catalyst comprises at least 95% of the sum of the elements Sn, O, and S.

4. The catalyst of claim 1 comprising a sulfur content of 1.2 to 1.6 atom%.

5. The catalyst of claim 4 wherein sulfur atoms are dispersed in a surface of the SnO₂.

6. A catalyst ink comprising;
a liquid carrier;
conductive particles; optionally an ionomer, and
the catalyst of claim 1.

7. The catalyst ink of claim 6 wherein the conductive particles comprise conductive carbon.

8. The catalyst ink of claim 7 comprising an alkaline ionomer binder.

9. The catalyst ink of claim 6 wherein the liquid carrier comprises deionized water.

10. The catalyst ink of claim 9 further comprising isopropanol, methanol, ethanol, or other suitable organic solvent.

11. A method of making a catalyst comprising heating tin oxide powder in the presence of sulfur to produce tin oxide doped with sulfur, wherein the sulfur concentration is between 0.1 to 2 at%.

12. The method of claim 11 further comprising mixing the tin oxide and sulfur powders prior to heating.

13. The method of claim 11 wherein the mixture of tin oxide and sulfur is heated to a calcination temperature of between 350 and 750° C.

14. The method of claim 13 comprising mixing tin oxide with sulfur at a SnO₂:S molar ratio of between 1:0.2 and 1:15.

15. The method of claim 11 wherein the step of heating is conducted at least 350° C.

16. The method of claim 13 wherein calcination temperatures are in the range of 400 to 700° C.

17. (canceled)

18. A catalyst made by reducing the catalyst of claim 1 during a CO2 reduction reaction to form metallic tin in the catalyst.

19. A S-SnO₂ catalyst-containing gas diffusion electrode comprising the catalyst of claim 1 dispersed onto a carbon paper electrode.

20. The S-SnO₂ catalyst-containing gas diffusion electrode of claim 19 comprising an ionomer or other suitable binder.

21. The S-SnO₂ catalyst-containing gas diffusion electrode of claim 19 characterizable by Faradaic efficiency of at least 60%, if measured according to the electrochemical method described in the examples.

22-31. (canceled)
